(19) United States
(12) Patent Application Publication
(10) Pub. No.: US 2005/0108707 A1
(43) Pub. Date: May 19, 2005

(54) Systems and methods for creating and managing a virtual retail store on end-user client computers within a network

(76) Inventors: Thomas M. Taylor, Kelowna (CA); Robert Arn, Kelowna (CA)

Correspondence Address: Clifford W. Vermette, Vermette & Co.;Suite 230, Box 40, Granville Square, 200 Granville Street, Vancouver, BC, V6C 1S4, CA

(21) Appl. No.: 10/986,769

(22) Filed: Nov. 15, 2004

Related U.S. Application Data
(60) Provisional application No. 60/519,643, filed on Nov. 14, 2003.

(51) Int. Cl. G06F 9/445

(52) U.S. Cl. 717/177

(57) ABSTRACT

Systems and methods for adapting a client computer in a network so that it is loaded with software that is available for purchase or demonstration, evaluation, advertising or solicitation and the user is provided with the ability to select desired software and effect a commercial transaction to license use of the software on the client computer or purchase goods and services is described.

### FIELD OF THE INVENTION

This invention pertains to the distribution and offer for purchase of software on computer networks. More specifically, it describes a system and method of creating a “virtual retail store” on the client computer of an end-user in a network, whereby software may be loaded in the spare capacity of the client computer storage system and facilities provided to allow the end-user to effect a transaction to license demonstration, evaluation, or use of application software and data on the client computer as well as purchase other goods and services.

### BACKGROUND OF THE INVENTION

Distribution methods and infrastructure for the sale of commercial software (including business, personal productivity, interactive games, audio and video content and other forms) have evolved rapidly with the growth of the computer industry and particularly with the spread of global networks such as the Internet.

The original physical distribution model, whereby mechanical copies of software, originally floppy disks and game cartridges, now primarily CDs and DVDs, were stocked on the shelf space of retail software stores is still a major, if declining business model. Many variants to the physical distribution model have been used, some of which eliminate the retail store. For instance, software CDs are widely distributed with print publications and purchased objects ranging from printers to breakfast cereal, which attempt to generate revenue by various schemes, including trial versions that have limited time or limited functionality features that encourage users to upgrade to full versions by various channels.

Some software is routinely licensed and distributed pre-loaded along with computer systems, but this is largely limited to basic operating systems for which the customer makes a purchase decision associated with the hardware purpose.

On-line distribution of software through network downloading is very widespread, but more as an update mechanism than as a primary purchase mechanism, limited by a number of factors, including a remaining number of potential customers that lack broadband network connectivity, and concern from publishers about the potential dangers of illegal copying of digital works once they are separated from physical distribution media.

Overall, software distribution modes balance three basic technical factors: transport cost/capacity and distribution medium cost/capacity and shelf space cost/capacity. Failures in any factor lead to customer support costs. Each is expressed differently in different technologies. In physical distribution systems one must calculate the cost and delays of traditional transport logistics systems which interact with the capacity and cost of CD or DVD distribution medium and the cost of physical retail shelf-space. In on-line distribution systems, the cost and data rates of network transmission and servers interacts with the characteristics of the electronic intangible distribution medium and the cost of shelf space can be mapped to the cost of creating and maintaining a commercially competitive commerce website.

In contrast to the constant change of technical modes of distribution, user goals in purchase of software tend to be relatively stable. Users value broad choice, easy comparison, low cost and immediacy of completing the purchase transaction. Each distribution mode exhibits strengths and weaknesses relative to these user goals, due to cost or capability limitations in the technologies exploited by the mode. The traditional retail store allows moderate choice and comparison, but tends to be weak in cost and immediacy since it requires expensive retail shelf space and physical travel by the customer. On-line distribution offers extraordinary choice but not necessarily easy comparison, good cost but often unexpected inconvenience and delay from long and unpredictable downloads. One can anticipate that as the capacities and costs of various technologies change, new distribution modes will arise to exploit the new capabilities to better approach the unsatisfied goals of prospective customers.

To simplify all the variables of distribution modes, one can ask the hypothetical question, “From the customer's viewpoint, where is the store?” For the traditional physical distribution model, the answer is simple. It is at a particular geographic location, on a street, in a mall, etc. For the network distribution model, the answer is more ephemeral. The store is on a server at a particular network address. However, in each case, evaluating the customer experience is the same. How easy is it to get there? What is on the shelf? How do I buy it? How do I get it home and functional?

The current invention describes a system and method for providing a different answer to these basic questions, one which exploits new cost/capacity trade-offs in the elements of software distribution, locating the store in the storage system of the customer's computer. In both the physical distribution and the network download distribution model the storage system capacity of the end user's computer is considered as a limiting factor rather than a potential resource. Hard disk space, for instance, has been regarded as scarce and expensive. However, the continual improvement of a real density of recording surfaces on hard drives has increased typical disk capacities to the point that vendors of hard drives are concerned that users will not find any use for the capacities that will soon become commonplace. The current invention describes a system and method for locating a virtual store on the storage system of a customer's computer rather than in physical space or remotely on the network. This distribution mode exploits the synergy of the continuing increase of storage system capacity and network bandwidth to provide greater simplicity and immediacy of purchase and installation of software than is available in either the physical or network download distribution and purchase model.

### SUMMARY OF THE INVENTION

A system and method for adapting a client computer in a network so that its storage system is loaded with software that is available for demonstration, evaluation, or full licensing, or which provides the capability of effecting a purchase of goods or services or responding to advertising or solicitation and the user is provided with the ability to select desired software and effect a purchase or a commercial transaction to license use of the software on the client computer is described.

In one embodiment of the invention, software for purchase or demonstration, evaluation, advertising or solicitation is pre-loaded on computer storage systems in the process of manufacture and distribution before they are sold to end users, either as part of computer systems, or as add-on enhancements for systems after purchase. The pre-loaded software includes facilities to contact a commercial entity through a telecommunications network and effect a purchase or a transaction to license use of the software on the computer and includes facilities to enable the full functioning of the licensed software.

In another embodiment of the invention, a software program is included with storage systems before they are sold to end users, either as part of computer systems, or as add-on enhancements for systems in use. Said software program may be provided as part of the installation program for said storage systems, or as a separate program to be optionally installed after installation of the storage system. Upon installation, said software program effects the provisioning of the storage system with software for purchase or demonstration, evaluation, advertising or solicitation by downloading it through a telecommunications network such as the Internet and provides facilities to contact a commercial entity through a telecommunications network and effect a purchase or a transaction to license use of the software on the computer and includes facilities to enable the full functioning of the licensed software.

In yet another embodiment of the invention, software for purchase or demonstration, evaluation, advertising or solicitation is pre-loaded on computer storage systems in the process of manufacture before they are sold to end users, either as part of computer systems, or as add-on enhancements for systems in use and a software program is included with storage systems before they are sold to end users, either as part of computer systems, or as add-on enhancements for systems in use. Said software program may be provided as part of the installation program for said storage systems, or as a separate program to be optionally installed after installation of the storage system. Upon installation, said software program requests copies of software for purchase or demonstration, evaluation, advertising or solicitation which is offered from one or more vendors through a telecommunications network such as the Internet, downloads said software, stores it on the storage system of the end user's computer and provides facilities to contact a commercial entity through a telecommunications network and effect a purchase or a transaction to license use of the software on the computer and includes facilities to enable the full functioning of the licensed software. This embodiment combines provisioning the computer system or storage system with software in advance of purchase with the ability to continually re-provision the computer system with new or enhanced software.

For each of the embodiments described, optional software management facilities are described which provide added functions for the selection, purchase, security and installation of the software for purchase or demonstration, evaluation, advertising or solicitation.

### BRIEF DESCRIPTION OF THE FIGURES

FIG. 1A is a block diagram of a system used in practicing an exemplary embodiment of the invention in which software is pre-loaded on the storage system of an end-user's computer system.

FIG. 1B is a block diagram of a system used in practicing an exemplary embodiment of the invention in which software is loaded on the storage system of an end-user's computer system through network download.

FIG. 1C is a block diagram of a system used in practicing an exemplary embodiment of the invention in which software is pre-loaded on the storage system of an end-user's computer system and re-provisioned through network download.

FIG. 1D is a block diagram of a system used in practicing an exemplary embodiment of the invention in which software is loaded on the storage system of an end-user's computer system through network peer-to-peer download.

FIG. 1E is a block diagram of a system used in practicing an exemplary embodiment of the invention in which transactions are executed via telephone communications FIG. 2 is a block diagram of a software management facility which may optionally be part of each embodiment of the invention to provide consistent interaction patterns with the various software loaded on the system.

FIG. 3A is a block diagram of a virtual application environment which may optionally be part of each embodiment of the invention that serves as an isolation proxy for software loaded on the system.

FIG. 3B is a block diagram of a preferred embodiment of a virtual application environment which may optionally be part of each embodiment of the invention that serves as a software installation proxy.

FIG. 3C is a block diagram of a preferred embodiment of a virtual application environment which may optionally be part of each embodiment of the invention is enhanced by inclusion of a commercial digital rights management system.

FIG. 3D is a block diagram of a preferred embodiment of a virtual application environment which may optionally be part of each embodiment of the invention which serves as a simple copy protection mechanism for software loaded on the system.

### DETAILED DESCRIPTION OF THE PREFERRED EMBODIMENTS

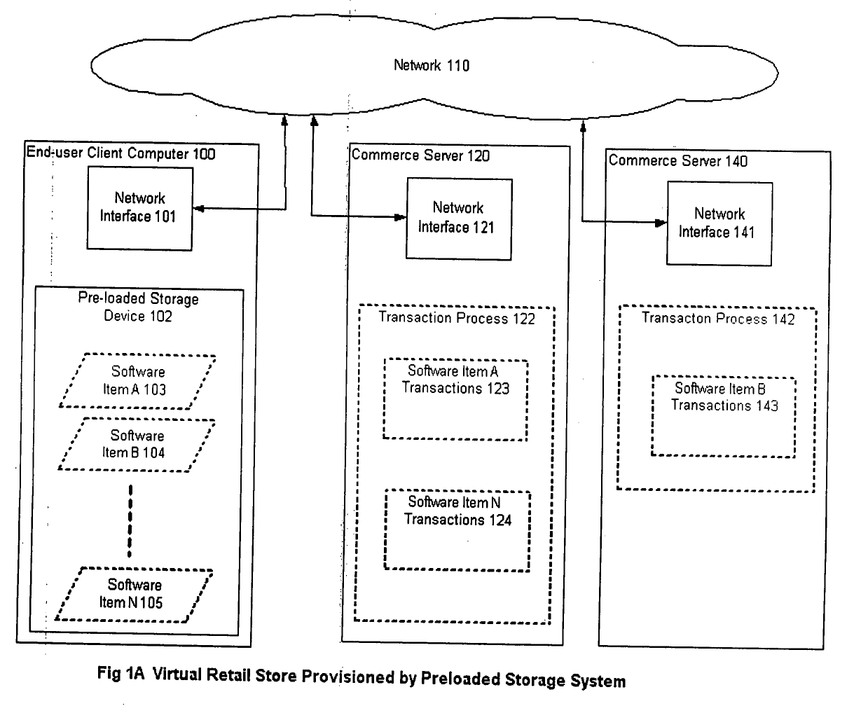

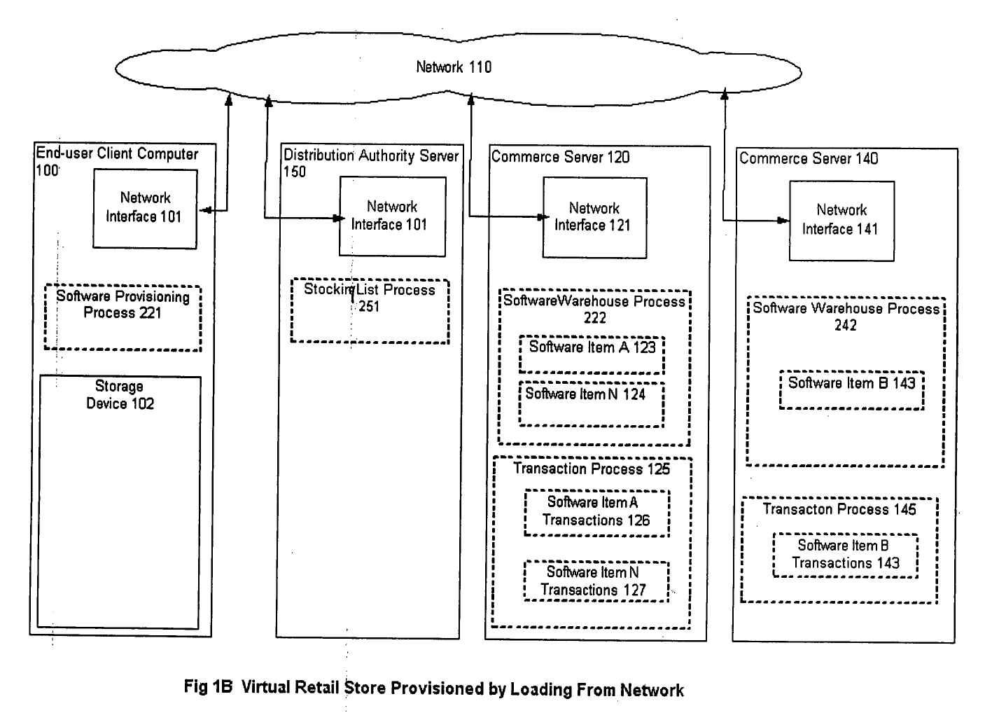

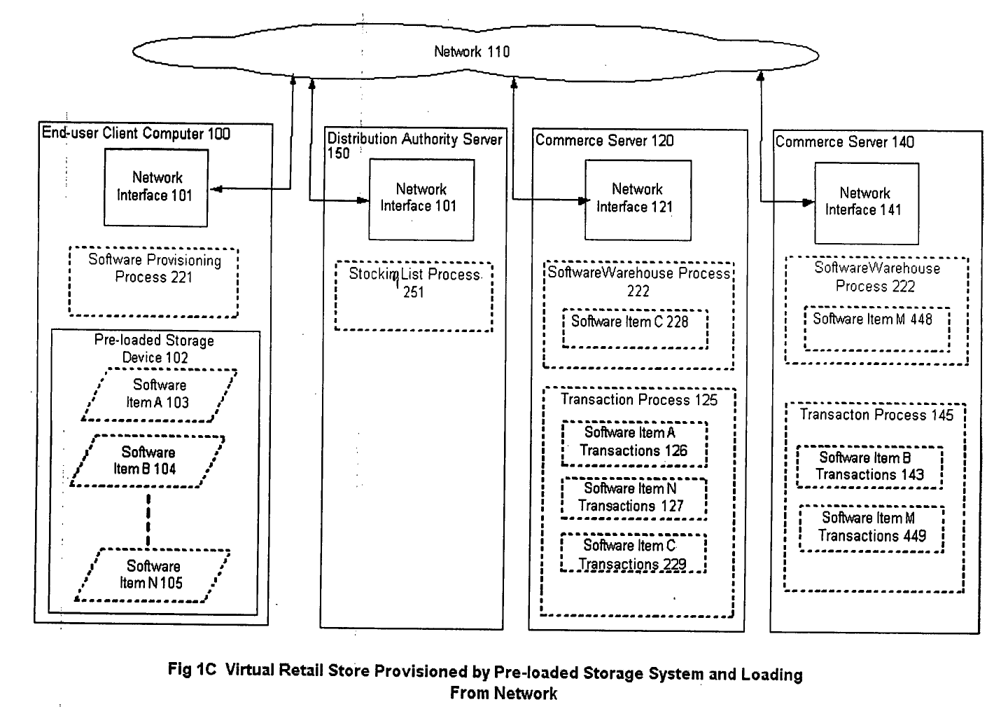

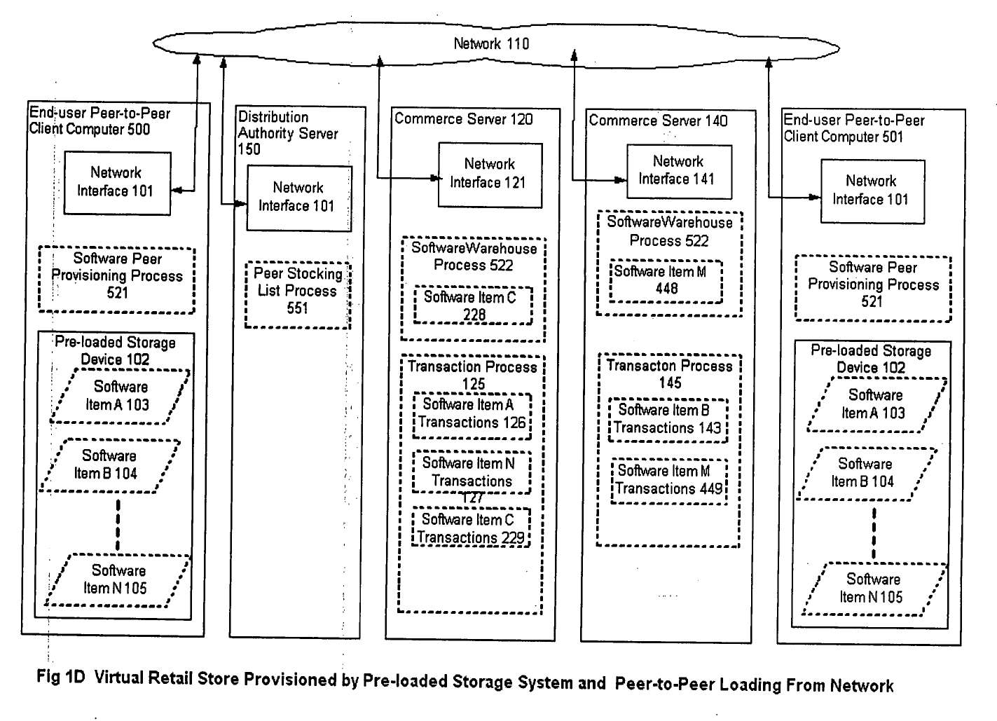

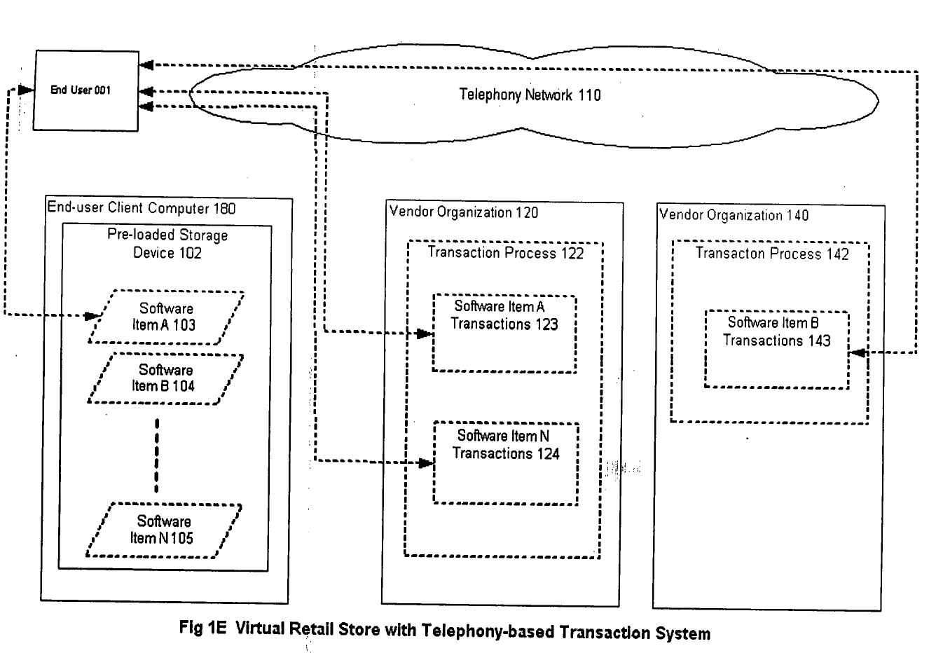

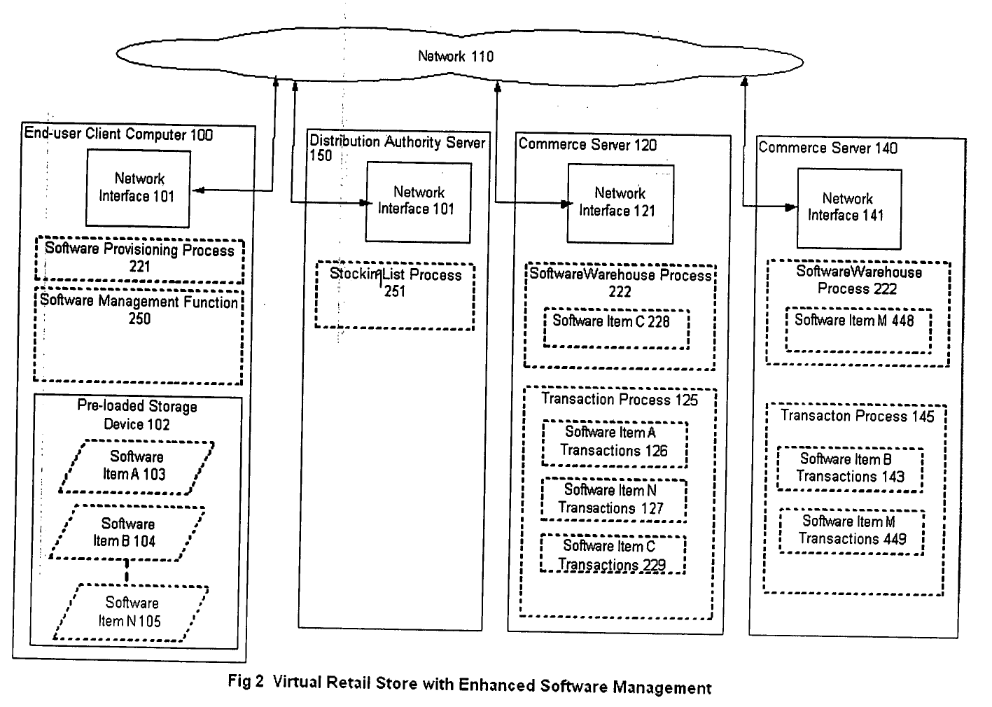

FIG. 1A shows a system comprising an end-user client computer representative of a plurality of end-user client computers and a plurality of commerce servers communicating over a network in the practice of an embodiment of the invention. An End-user Client Computer 100 communicates through Network Interface 101 over a Network 110 such as the Internet with a Commerce Server 120 through Network Interface 121 and another Commerce Server 140 through Network Interface 140. A practitioner skilled in the art will understand that the representation of End-user Client Computer 100 is simplified for purposes of description of the invention and may be assumed to be a typical end-user personal computer which includes, as well as the explicitly shown network interface and storage system a CPU, RAM, Display, User-interaction devices such as a keyboard and pointing device, operating system software and, in the case that the network is the internet, web browser software and that the end-user client computer is capable of installing and running application programs. Equally, such a skilled practitioner will recognize that the representation of Commerce Servers 120 and 140 is simplified for purposes of description of the invention and may be assumed to be a typical network server computers which include, as well as the explicitly shown network interface, a CPU, RAM, Storage System, operating system software and, in the case that the network is the internet, HTTP protocol web server software and commerce application software adequate to support the described transaction processes. Further, said skilled practitioner will understand that the representation of a single end-user computer in the system is a simplification for purposes of description of the invention and that the invention envisages in all embodiments that many end-user client computers would participate in the system simultaneously. Finally, said skilled practitioner would understand that the representation of two commerce servers in the system is a simplification for purposes of description of the invention, and that the invention envisages any number of servers from one server to as many servers as there may be independent transactions effected on the system and that individual servers may be replicated or mirrored as is typical in large-scale internet commercial systems. On End-user Client Computer 100, Pre-loaded Storage Device 102 is a storage device that has data pre-recorded on it in the process of manufacture or distribution, said data including in this representation, Software Item A 103, Software Item B 104 and Software Item N 105.

A skilled practitioner will understand that this representation should be interpreted as indicating that from one to many software items may be pre-loaded with an upper bound set by the storage capacity of the disk. Equally, said skilled practitioner will understand that there may be multiple storage units in end-user client computers, that storage units may be installed after the purchase of computers by end-users, that storage units may be installed inside the computer or externally as packaged units connected into the computer by cabling, that storage units communicate with the host computer via a plurality of protocols, that storage units may be constructed using different technologies such as fixed and removable magnetic media and fixed and removable optical media as well as many semi-conductor technologies and emerging technologies such as holographic storage and that the only essential limitation relating to this invention is that the storage device be capable of being pre-loaded with data in the process of manufacture and distribution and retaining that data until it is installed in the computer either in the process of manufacture and distribution of the computer, or by the end-user after purchase of the computer.

The plurality of Software Items A through N may be any digital data, including for example, executable application programs, utilities or operating software, source code, interpreted codes and byte-codes that execute via a virtual machine, add-on functions or data for any form of program, and data for execution on any program whether in a standardized or proprietary form, including, for example, music and/or audio data, digital photography data, graphics data and 3D model data, video and/or motion picture data, multi-media content, and links to any other function, code or data which might be accessed through a network.

On Commerce Server 120, Transaction Process 122 includes Software Item A Transactions 123 which are the collection of functions required to effect any commercial transaction via network interaction with End-user Client Computer 100 relative to Software Item 103 and also Software Item N Transactions 124 which are the collection of functions required to effect any commercial transaction via network interaction with End-user Client Computer 100 relative to Software Item 103 and on Commerce Server 140, Transaction Process 142 includes Software Item B Transactions 143 which are the collection of functions required to effect any commercial transaction via network interaction with End-user Client Computer 100 relative to Software Item 103. A practitioner skilled in the art will understand that pre-loaded software items on Pre-loaded Storage Device 102 will be visible to the user of End-user Client Computer 100 through the file system of the operating system. When activated by the user through the conventions of the operating system, a software item will display the transactions that may be effected relative to that software item or may query the commerce server that manages transactions relative to that software item to return a list of the transactions that may be effected relative to that software item. Such commercial transactions can take a number of forms, including, for instance, licensing the software for demonstration, evaluation, or use, as well as purchase of other goods and services and advertising or solicitation.

To clarify the method of the invention, representative exemplary transactions are described. For example, activation of Software Item A 103 might reveal options for demonstration, evaluation or full use of an application contained in Software Item A. Choosing said demonstration option sends a request for a demonstration transaction to Commerce Server 120 Software Transactions 123 and activates the demonstration function there contained which returns a demonstration activation message to the Software Item A 103 process which then activates the functions for demonstration of the application contained in Software Item A 103. At this point, the user will have entered into a limited license relationship with the vendor party which operates the Commerce Server 120, but will not necessarily have tendered any payment. After viewing the demonstration, the user of End-user Computer 100 may return to the display of available transactions and select the evaluation option. Choosing said evaluation option sends a request for a evaluation transaction to Commerce Server 120 Software Transactions 123 and activates the evaluation function there contained which returns a evaluation activation message to the Software Item A 103 process which then activates the functions for evaluation of the application contained in Software Item A 103. At this point, the user will have entered into a limited license relationship with the vendor party which operates the Commerce Server 120 which grants, for example, full use of the functions of the application, but limits file saving, for a period of 30 days, but will not necessarily have tendered any payment, but may, for example, have provided some of the user's personal information to the vendor in consideration of the limited license granted by the vendor. After using the application for a period of time, the user of End-user Computer 100 may return to the display of available transactions and select the purchase license option. Choosing said purchase license option sends a request for a purchase license transaction to Commerce Server 120 Software Transactions 123 and activates the purchase license function there contained which initiates a registration and payment function there contained and after a sequence of requests and responses to close a registration and payment sequence, issues a full license activation message to the Software Item A 103 process which then activates the functions for unlimited full function of the application contained in Software Item A 103. At this point, the user will have entered into a paid full function license relationship with the vendor party which operates the Commerce Server 120 which grants unlimited use of the application on the End-user Client Computer 100. A practitioner skilled in the art will recognize that the detailed transaction sequences described in relation to Software Item A 103 are merely exemplary of a much broader set of commercial transactions that might be supported in a system practicing the invention. For instance, different types of applications or content that might be contained in a pre-loaded software item might provide transactions for paid single use or rental of the application or content.

To further clarify the method of the invention, additional representative exemplary transactions are described. For example, activation of Software Item B 104 might reveal options to purchase tangible goods or services of any sort. Such an option might offer an option to activate an advertisement or solicitation associated with Software Item B such as an interactive video presentation of the product that would otherwise be time-consuming to download from the network, followed by an option to purchase. Choosing said purchase license option sends a request for a purchase transaction to Commerce Server 140 Software Item B Transactions 143 and activates the purchase license function there contained which initiates a registration and payment function there contained and after a sequence of requests and responses to close a registration, payment and delivery sequence, returns a receipt of sale to the user on End-user Client Computer 100 and initiates a separate fulfillment process relative to the vendor's supply chain. However, simply choosing to view the advertisement or solicitation could initiate a transaction whereby a message is sent to the Commerce Server 140, Software Item B Transactions 143 advertising and solicitation function whereby the Server registers a viewing of the advertisement or solicitation and uses such records to support a paid advertising relationship with a third party who has contracted for advertising relative to the goods or services offered through Software Item B 104 and Software Item B Transactions 143.

FIG. 1B shows a system comprising a representative end-user client computer and a plurality of commerce servers communicating over a network in the practice of another embodiment of the invention whereby instead of pre-loading all the software for licensing or purchase or advertising and solicitation on the storage system of the end-user's computer in advance, a software provisioning application is pre-loaded on the storage system in advance, or is made available for installation on the end-user's system. Upon installation or activation, said software provisioning application causes the end-user's computer system to download software in the background when the computer is not active with user-initiated functions until all of the available software items are stored on the end-user client computer ready to initiate licensing, purchase, or advertising and solicitation transactions.

The system of FIG. 1B is essentially the same as that of FIG. 1A with the exception that a Software Provisioning Process is added to the storage device which starts empty of any software items and a Software Warehouse Process is added to each Commerce Server which includes all the data necessary to transfer a software item to an end-user client on request. Optionally, a Distribution Authority Server in FIG. 1B, Storage Device 102 in this embodiment of the invention begins empty of pre-loaded software items. A Software Provisioning Process 221 is either pre-installed on the End-user Client Computer 100, or may be installed as part of the installation of Storage Device 102 in the case that said storage device is installed after the purchase of said computer system, or may be installed in the manner of independent software applications from a distribution disk or by download from a network. A Software Warehouse Process 222 is installed on Commerce Server 122 and a Software Warehouse Process 242 is installed on Commerce Server 140. Software Provisioning Process 221 provides a means by which the user may authorize the provisioning of all or a part of the software items that are available for provisioning on the respective Commerce Servers. If the full set of available software items is stable and known in advance, the Software Provisioning Process 221 may make direct requests to the Commerce Servers providing the desired categories of software items. For instance, Software Provisioning Process 221 might send requests for all stocked software items Software Warehouse Process 222 and Software Warehouse Process 242 which would return Software Item A 123 Software Item N 124 and Software Item B 143 from Commerce Servers 120 and 140, said software items then, under control of Software Provisioning Process 221 being stored on Storage Device 102, resulting in a state identical to the pre-loaded state described in FIG. 1A.

In the case that the full identity and location of all software items is not known in advance, the request may be made to a Distribution Authority Server 150 which contains a Stocking List Process 151 which is maintained to contain an up-to-date listing of all Commerce Servers and their contents. In reply to said request, Distribution Authority Server 150 returns a listing of available software items to Software Provisioning Process 221, whereupon the user may request that part or all of the available software items be provisioned on Storage Device 102 whereupon the interaction between software provisioning process and software warehouse processes would proceed in the manner already described above. Once the provisioning process is complete, the user is able to initiate licensing or purchase or advertising or solicitation transactions in the manner already described in relation to FIG. 1A above. This embodiment provides the advantage of being able to dynamically add further software items as they may be added to the various commerce servers that provision the virtual store on the storage device on the end-user's client computer.

FIG. 1C shows block diagram of a system comprising a representative end-user client computer and a plurality of commerce servers communicating over a network in the practice of another embodiment of the invention whereby instead of pre-loading all the software for licensing or purchase or advertising and solicitation on the storage system of the end-user's computer in advance, some of said software is so pre-loaded and as well, a software provisioning application is pre-loaded on the storage system in advance, or is made available for installation on the end-user's system. As will be evident to a skilled practitioner, this system is a combination of the embodiments already described in relation to FIG. 1A and FIG. 1B above. It starts with a selection of software items pre-loaded and then provides means to dynamically add further software items as they may be added to the various commerce servers that provision the virtual store on the pre-loaded storage device on the end-user's client computer.

FIG. 1D shows block diagram of a system comprising a plurality of end-user client computers and a plurality of commerce servers communicating over a network in the practice of another embodiment of the invention. This embodiment is similar to the embodiment practiced in relation to FIG. 1C, with the addition that End-user Peer-to-Peer Client Computers 500 and 501 have added functions to allow them to distribute software items to other end-user peer-to-peer client computers. In FIG. 1D distribution of software items may be commenced by pre-loading the software items on the storage system of the client peer-to-peer computer or by network download as described relative to FIG. 1C. In the case of network download, End-user Peer-to-Peer Client Computers 500 and 501 both start without Software Item M 448. If End-user Peer-to-Peer Client Computer 500 requests a re-stocking of software items that includes Software Item M 448, the message will be send from Software Peer Provisioning Process 521 to Distribution Authority Server 150 Peer Stocking List Process 551 which will redirect it to Commerce Server 140 which will respond by downloading the said software item. If, End-user Peer-to-Peer Client Computer 501 subsequently makes a request for a re-stocking of software items that includes Software Item M 448 the request through Distribution Authority Server 150 Peer Stocking List Process 551 may be redirected to End-user Peer-to-Peer Client Computer 500 instead of, or in addition to, Commerce Server 140. A skilled practitioner will recognize that the described embodiment is an illustrative example and there are many different variants to of peer-to peer configurations that all provide similar utility in that they reduce the load on the commerce servers and associated network infrastructure and hence reduce the cost of building and operating the system. The skilled practitioner will also understand that the described embodiment does not compromise the security of the software items that are distributed between end-user peer-to-peer client computers because the authorization and enablement of functions in the software items is still managed by a dialog with the commerce servers which handle the transaction processing.

FIG. 1E shows block diagram of a system similar to the embodiment described relative to FIG. 1A in the practice of another embodiment of the invention, comprising a representative end-user client computer and a plurality of commerce servers, except that the client computer 180 is not connected to a computer network and the end user 001 communicates with the commerce servers via voice communications on a telephony network. In this embodiment, the End-user 001 selects a Software Item A 103 and contacts a Vendor Organization 120 via voice telephony. A human party or an automated interactive telephony application leads the user through the desired transaction in Software Item A Transactions 123, which might include, for example a credit card payment interaction. At the end of the transaction, the Vendor Organization 120 provides the End-user 001 with some data such as a key sequence which the End-user manually enters into a dialog as authorization of the desired function in Software Item A 103.

FIG. 2 shows block diagram a system comprising a representative end-user client computer and a plurality of commerce servers communicating over a network in the practice of another embodiment of the invention whereby a Software Management Function is added to any of the embodiments described in FIGS. 1A-1E to coordinate the user's access to software items and to transactions. The embodiments as described in relation to FIGS. 1A-1D show methods in which each software item may be considered a separate unit, in that selecting any software item will initiate a transaction sequence that is unique to that software item and similar transactions may be handled differently in relation to specific user interactions and appearances of user interfaces. Such variation in interaction with a plurality of similar items can be confusing to users. Hence the current embodiment adds a Software Management Function 250 through which user interaction with the software items is channeled and which provides a common user interface and procedure for all transactions relating to all of the software items. Thus, for example, through said software management function, all License or Purchase transactions would be carried out with the same user interactions and appearance, reducing the likelihood of user confusion.

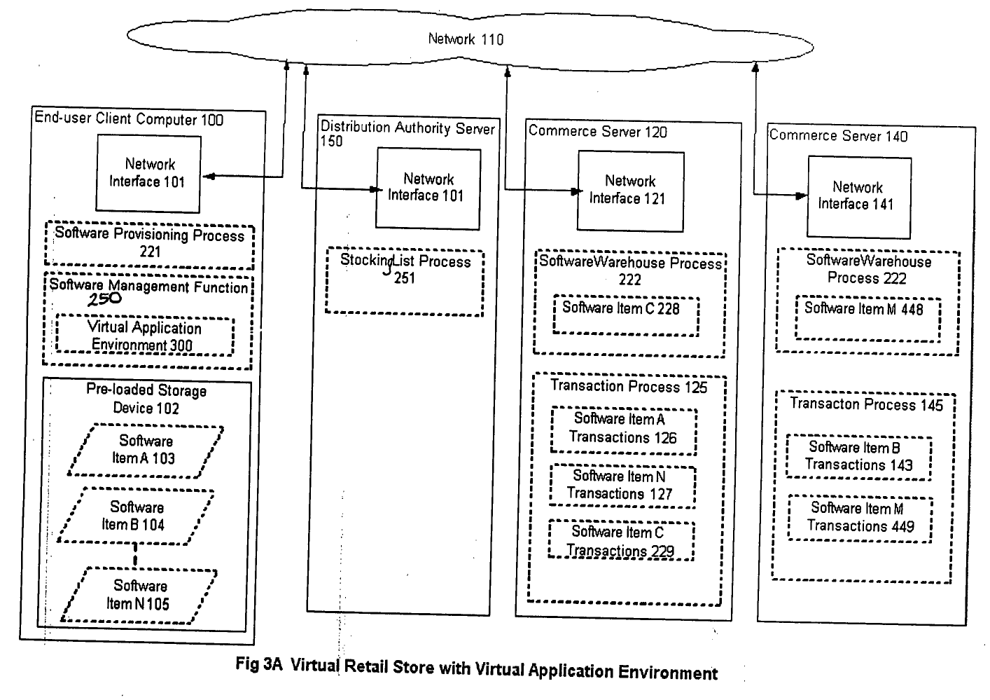

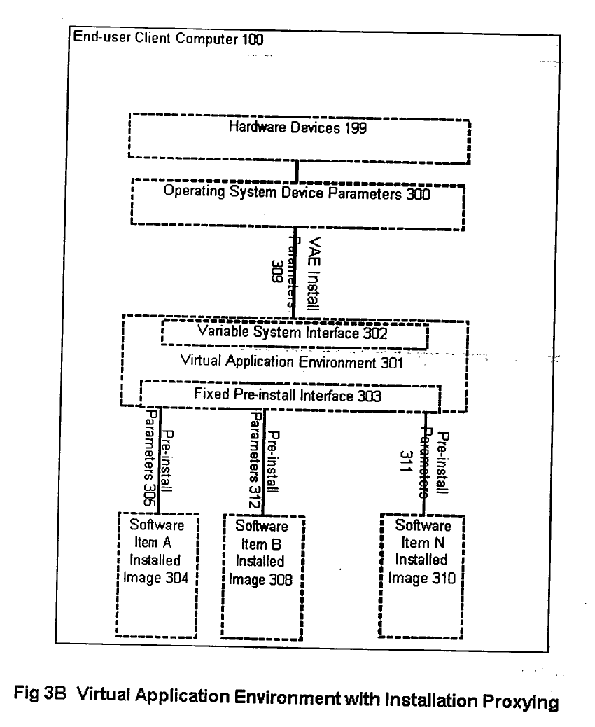

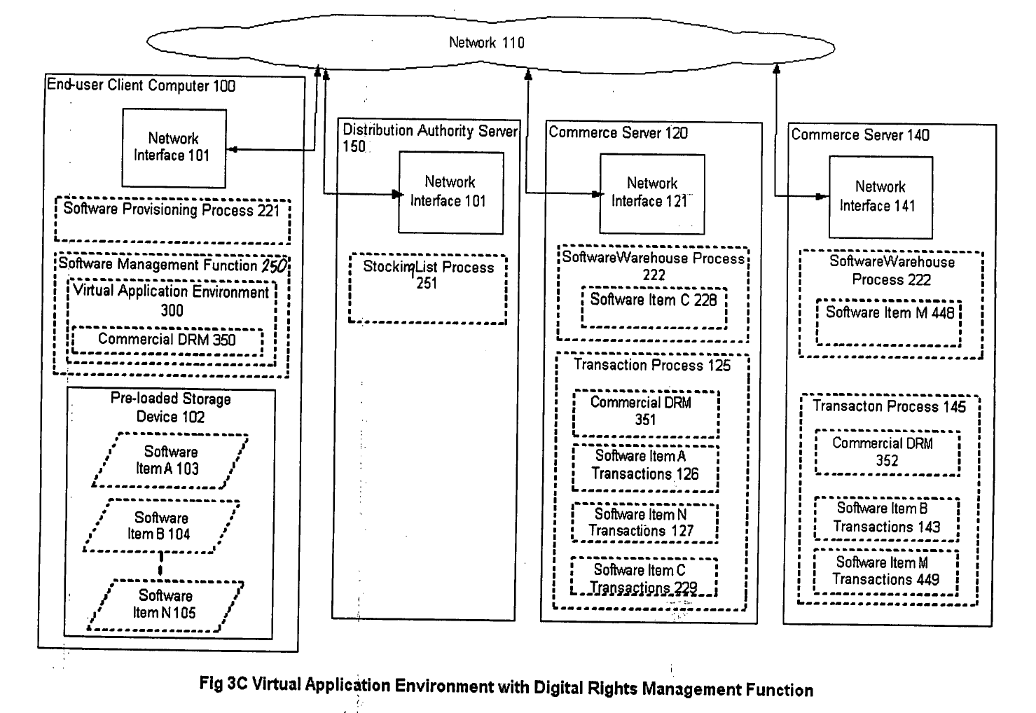

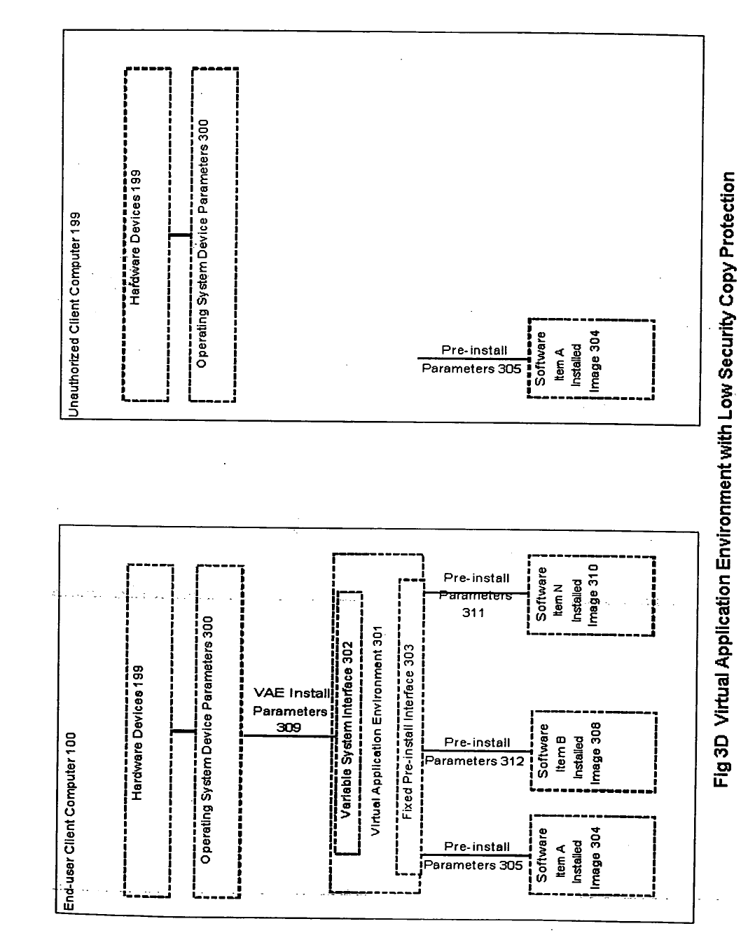

FIG. 3A shows block diagram a system comprising a representative end-user client computer and a plurality of commerce servers communicating over a network in the practice of another embodiment of the invention whereby a Virtual Application Environment is added to the Software Management Function as described in FIG. 2 to provide added convenience, functionality or simplicity to the user. This embodiment adds a Virtual Application Environment 300 to said Software Management Function 250. Said Virtual Application Environment serves as an isolation proxy for any of the software items that are loaded on the storage devices of any of the described embodiments so that communication of user interaction events, and/or program parameters, and/or data between said software items and the operating environment passes through said Virtual Application Environment, allowing the introduction of control functions that may be applied to any and all of the plurality of software items, bypassing or enhancing functions of the software items as well as adding new functionality. Such functions might include monitoring functions, software management functions, logging functions, enhanced or simplified installation functions, security or rights management functions and many other functions which will be evident to a skilled practitioner. For greater certainty of understanding the general function of said Virtual Application Environment, several specific preferred embodiments will be described.

FIG. 3B shows a block diagram of a specific preferred embodiment of the Virtual Application Environment used in the practice of the invention which acts as an installation proxy for multiple software applications. The Software Management Function 250 as described in FIG. 2 provides a unified set of interactions to manage similar transactions in similar ways, reducing the potential confusion of users who are effecting a transaction in relation to any of the software items stocked in the virtual store. However, having completed a transaction, say for a full licensing of a software application, the user still has to install the software package to run on the client computer, a process which is time-consuming and potentially different in subtle ways for each separate software item. A practitioner skilled in the art will understand that most software that is used on an end-user computer contains a separate program or set of functions that allow the software as distributed to be copied to particular files and directories in storage system of the end-user's computer, from which it may be retrieved for execution, and moreover, that the parameters of the software that relate to specific capabilities of the computer's hardware and software be coordinated so that they operate to best effect. Such parameters, for example, among many others, often relate to such characteristics as display resolution, color depth, frame rate, audio characteristics such as number of channels, sampling rate, number of bits per sample and types of encoding, input device parameters and function/control mappings for keyboards, mice, joysticks and numerous specialized devices, and general resource allocations such as memory footprint and cache sizes and registration of the application with the operating system. The large number of such parameters and the variety of system configurations among computers make installation of software slow, confusing and error-prone. Such delays and confusion often deter users from undertaking demonstrations or evaluations of software that might lead to a licensing or purchase transaction. In FIG. 3B, the specific preferred embodiment of the Virtual Application Environment provides an installation proxy function which allows users to avoid having to undertake software installation procedures for any of the software items which are loaded on the system, thus eliminating the delay and confusion associated with such installation procedures. In FIG. 3B, the Virtual Application Environment 301 includes a Variable System Interface 302 and a Fixed Pre-install Interface 303. In various embodiments of the invention, the Virtual Application Environment 301 is configured relative to the operating software of the end-user's client computer, either in the process of manufacture and distribution of the system, or subsequently by the end-user. At such time, the parameters specific to the individual computer such as are mentioned above are set in the Variable System Interface 302 and the operating software communicated through VAE Install Parameters 309. As will be evident to a skilled practitioner, these parameters are specific to individual systems and cannot be known in advance. The other interface, the Fixed Pre-install Interface 303 is a function that represents all the same parameters as pre-set default values relative to the value categories of the Variable System Interface 302. These values are set to arbitrary typical values in advance and hence can be known before the installation of the Virtual Application Environment (as part of the over-all invention) is configured into a specific end-user computer. Thus, Software Items may be pre-installed in said Virtual Application Environment as “installed images”. That is, all of the installation parameters of Software Item A Installed Image 304, Software Item B Installed Image 308 and Installed Image 310 and Software Item N Installed Image 310 are communicated to the Fixed Pre-install Interface 302 through its respective Pre-install Parameters 305, 312 and 311. To restate the relationship for simplicity, any application software stored in a Software Item on the system, or loaded onto the system, is stored as an installed image without an installation function. It can be so installed because it is in fact installed in an environment which is known in advance and which isolates it from the variability of the actual end-user's computer environment which cannot be known in advance, such variables being instantiated upon the installation of the Virtual Application Environment which serves as a proxy for all of the software applications. As will be clear to a skilled practitioner, many variations and enhancements of this basic installation proxy function are likely, including, for example, provisions for the user to fine-tune or otherwise alter the parameters of individual software applications.

FIG. 3C shows a block diagram of another specific preferred embodiment of the Virtual Application Environment used in the practice of the invention which acts as a digital rights management function for multiple software applications. As will be known to a practitioner skilled in the art, systems which provide technological means of supporting the distribution and licensing of software often makes provision for the prevention of unauthorized use or copying of the software. Many such systems have been proposed in prior art and some have been reduced to commercial practice. A preferred embodiment of the Virtual Application Environment might optionally include such a commercially available digital rights management system as one of its functions. The Virtual Application Environment is capable of supporting a plurality of such systems because it serves as a path for all of the parameters, user interaction and data of the software items for which it acts as a proxy. Hence, installation of the desired digital rights management function in the Virtual Application Environment simplifies providing said digital rights management function to all of the software using the Virtual Application Environment as a proxy. FIG. 3C shows the system described in FIG. 3A extended with a commercial digital rights management function Commercial DRM 350 on the End-user Client Computer 100 and the Commerce Servers 120 and 140 with server-side digital rights management functions in Commerce DRM 351 and 352 respectively. An end-user request for a transaction, for example a request to license and use Software Item A, generates a request from End-user Client Computer 100 directly to Commerce Server 120, or indirectly through Distribution Authority Server 150 as the case may be, but before the transaction can be finally executed by Software Item A Transactions 126, the transaction must be authorized by Commercial DRM 351 which authorization may be contingent on parts of the said transaction process such as registration or payment. Once the transaction is authorized by interaction between Software Item A Transactions 126 and Commercial DRM 351, an authorization message is sent to Commercial DRM 350 on End-user Client Computer 100 which enables the retrieval and execution of Software Item A 103. A skilled practitioner will be aware that Commercial DRM systems use a variety of methods of blocking the use of software until a specified user event has occurred (usually some form of payment or registration or identity authentication) and use a corresponding variety of methods of enabling the use of software once said user event has occurred. Equally, it will be clear to such a skilled practitioner that the execution of Software Item A 103 may initiate a subsequent chain of transactions and interactions between Commercial DRM 350, Software Item A Transactions 125 and Commercial DRM 351. As well, it will be obvious that the same described method could be used relative to any of the software items shown in FIG. 3C.

FIG. 3D shows a block diagram of a specific preferred embodiment of the Virtual Application Environment used in the practice of the invention which acts as a simple low to moderate security copy protection mechanism for multiple software applications. In many practical commercial situations, it is not desirable to totally prevent unauthorized uses of the protected software if the cost or complexity of the required system reduces sales, induces customer resistance, or raises operating or customer support costs unduly. In such cases, the protection mechanism may be designed as a simple practical barrier to unauthorized usage rather than a complete prevention mechanism. FIG. 3D shows such a simple low to medium security copy protection mechanism which can be circumvented by a determined expert, but which poses a significant barrier to the average user. FIG. 3D shows a comparison is shown between the system described in FIGS. 3A and 3B and an unauthorized attempt to copy the files as shown in FIG. 3B onto a computer that is not part of the virtual retail store system as described in any of the previous figures. In FIG. 3D, End-user Client Computer 100 is identical to that in FIG. 3B. Copying the files for Software Item A from End-user Client Computer 100 to Unauthorized Client Computer 199 results in the configuration there shown where the Software Item A is now resident on Unauthorized Client Computer 199, but the user of said computer has no way to actually use the software because the Virtual Application Environment 301 is not available to interpret the Pre-install Parameters 305 to the operating system which would register the application and set the required Operating System Device Parameters 300. Since the files of Software Item A do not include an installer, as would an application which is distributed by traditional means, it is not directly possible for the user of Unauthorized Client Computer 199 to use the software at all, even though the executable files have been copied to his or her computer.

It will be clear to a skilled practitioner that such an arrangement is not totally secure. Two paths are possible to bypass the modest security level which is provided. First, a skilled programmer could reverse engineer the data of the installed image of the software item and create an installer which could interpret the installation parameters required for the software item and use said installer to install the software item. Second, a skilled programmer could reverse engineer the Virtual Application Environment itself, and create a false Virtual Application Environment which might execute whatever authorizations were required to activate the software item without communicating with a Commerce Server. Nevertheless, the described embodiment is useful in that it places a barrier before the average user that prevents simple copying and forces the skilled transgressor into means which are clearly illegal, which simplifies the process of enforcing the rights holders rights through legal as opposed to technical channels.

While the particular embodiments of systems and methods for creating and managing a virtual retail store on end-user client computers within a network as herein shown and described in detail are fully capable of attaining the above-described objects of the invention, it is to be understood that they are the presently preferred embodiments of the present invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. sctn.112, sixth paragraph, unless the element is expressly recited using the phrase “means for” or, in the case of a method claim, the element is recited as a “step” instead of an “act”.

1. A system for providing virtual retail distribution of multiple software items in a network and the capability to effect commercial transactions relative to the software from a client computer on the network, the system including
a network,
a plurality of client computers which include storage systems on which the software items have been pre-loaded, and functions that allow the user to select software items and make requests to commerce servers for transactions via the network and to activate functions in the software items in response to authorizations of the requested functions,
a plurality of commerce servers which include functions to receive and respond to requests from client computers and to authorize functions in the software items on the client computer once the pre-conditions of the transaction have been met.

2. A system for providing virtual retail distribution of multiple software items in a network and the capability to effect commercial transactions relative to the software items from a client computer on the network, the system including
a network,
a plurality of client computers which include storage systems which are initially empty of software items,
functions that may be pre-installed or user-installed that make requests to a plurality of commerce servers to download a number of software items and store them on the storage system of the client computer and allow the user to select software and make requests to commerce servers for transactions via the network and to activate functions in the software in response to authorizations of the requested functions,
a plurality of commerce servers which include functions store software items and to respond to requests from client computers for software items and to download software items, and to receive and respond to requests from client computers for transactions and to authorize functions in the software on the client computer once the pre-conditions of the transaction have been met, and
a distribution authority server which redirects requests for transactions or for downloading of software items or lists of available software items to the commerce servers which are capable of servicing such requests.

3. A system for providing virtual retail distribution of multiple software items in a network and the capability to effect commercial transactions relative to the software items from a client computer on the network, the system including
a network,
a plurality of client computers which include storage systems on which an initial set of software items have been loaded,
functions, which may be pre-installed or user-installed, that make requests to a plurality of commerce servers to download a number of software items and store them on the storage system of the client computer to augment the collection of pre-loaded software items, and functions to allow the user to select software and make requests to commerce servers for transactions via the network and to activate functions in the software in response to authorizations of the requested functions,
a plurality of commerce servers which include functions to store software items and to respond to requests from client computers for software items and to download software items, and to receive and respond to requests from client computers for transactions and to authorize functions in the software on the client computer once the pre-conditions of the transaction have been met, and
a distribution authority server which redirects requests for transactions or for downloading of software items or lists of available software items to the commerce servers which are capable of servicing such requests.

4. A system for providing virtual retail distribution of multiple software items in a network and the capability to effect commercial transactions relative to the software items from a client computer on the network, the system including
a network,
a plurality of client computers which include storage systems on which an initial set of software items have been pre-installed, including functions, which may be pre-installed or user-installed,
that make requests to a plurality of commerce servers or to other client computers to download a number of software items and store them on the storage system of the client computer to augment the collection of pre-loaded software items, and
functions to allow the user to select software and make requests to commerce servers for transactions via the network and to activate functions in the software in response to authorizations of the requested functions, and
as well peer-to-peer functions whereby the client computer is capable of storing software and responding to requests from client computers for software items and downloading software items to client computers, and
a plurality of commerce servers which include functions to store software items and to respond to requests from client computers for software items and to download software items, and to receive and respond to requests from client computers for transactions and to authorize functions in the software on the client computer once the pre-conditions of the transaction have been met, and
a distribution authority server which redirects requests for transactions or for downloading of software items or lists of available software items to the commerce servers or client computers which are capable of servicing such requests.

5. A storage system which is sold to end-users or OEM equipment manufacturers or distributed through a multi-tier distribution system pre-loaded with software items and functions, pre-installed or user installed, that allow the user to select software items and make requests to commerce servers for transactions via the network and to activate functions in the software items in response to authorizations of the requested functions

6. An end-user computer system which is sold to end-users or distributed through a multi-tier distribution system containing a storage system pre-loaded with software items and functions, pre-installed or user installed, that allow the user to select software items and make requests to commerce servers for transactions via the network and to activate functions in the software items in response to authorizations of the requested functions.

7. The system of claim 1 where transactions are conducted through a voice telephony network mediated by the end-user and a human representative of the commercial entity or an automated telephony application.

8. The systems of claims 1 to 6 where the network is a wide-area or global network such as the internet.

9. The system of claims 1 to 6 where the network is a local area network in a business office or home or other setting.

10. The system of claims 1 to 6 where the network is a wireless network such as IEEE 802.11a, b, g or other variant, Bluetooth, any cellular telephony variant that carries digital data, ultra-wideband wireless network, or any other wireless network.

11. The system of claims 1 to 6 where the software items consist of one or more types of software, including computer application software, games, operating software, utilities, updates, expansion paks, plug-ins, application data, scripts, music, still photographs, film, audio, video, or multi-media, interactive models, databases, or any other executable or source code or data.

12. The system of claims 1 to 6 where the software items consist of advertising, solicitation or promotional materials which may be selected to initiate a transaction to purchase, lease, rent, license, or otherwise gain rights to enjoy tangible goods or services.

13. The system of claims 1 to 6 where the storage system is one or more of any of recordable storage device type such as magnetic storage devices such as hard disk drives and floppy disk drives and magnetic tape drives, or optical storage devices such as recordable compact disc drives, or recordable DVD drives, or holographic memory, or semiconductor mass memory devices, or any other mass memory device.

14. The system of claim 1 where the storage system is one or more of any of recordable storage device type such as magnetic storage devices such as hard disk drives and floppy disk drives and magnetic tape drives, or optical storage devices such as recordable compact disc drives, or recordable DVD drives, or holographic memory, or semiconductor mass memory devices, or any other mass memory device, or any non-recordable storage device such as optical disk drives such as compact discs and DVDs.

15. The system of claims 1 to 6 where the storage system integrates with a computer through one or more means such as an internal system coupled through the system bus of the client computer, an internal or external system coupled through a cable and connector and a protocol such as USB, Firewire, RAID, Fibrechannel, Infiniband or any other form of coupling.

16. The system of claims 1 to 6 where the storage system is a stand-alone storage system such as a Network Attached Storage system or Storage Area Network system or Storage Appliance which interacts with a client computer through a network.

17. A method of providing virtual retail distribution of multiple software items in a network and the capability to effect commercial transactions relative to the software from a client computer on the network, whereby
software items are pre-loaded on a mass storage system
the mass storage system is integrated into a client computer system
functions are provided to:
allow the user to select software items,
make requests to commerce servers for transactions via a network,
manage requested transactions from a commerce server by communication with the client computer system through a network,
activate functions in the software items on the client computer system in response to authorizations of the requested functions from the commerce server.

18. A method of providing virtual retail distribution of multiple software items in a network and the capability to effect commercial transactions relative to the software from a client computer on the network, whereby
a mass storage system is initially empty of software,
the mass storage system is integrated into a client computer system,
functions are provided:
to allow the storage system to be stocked with software items by communicating a request to a distribution authority server that has knowledge of the software items contained on one or more commerce servers,
the distribution authority server returning a listing of available software items for selection, or alternatively re-directing a request for a specific software item to the appropriate commerce server,
the commerce server downloading the requested software items to the storage system on the client computer
allowing the user to select software items, to make requests to commerce servers for transactions via a network,
to manage requested transactions from a commerce server by communication with the client computer system through a network,
activate functions in the software items on the client computer system in response to authorizations of the requested functions from the commerce server.

19. A method of providing virtual retail distribution of multiple software items in a network and the capability to effect commercial transactions relative to the software from a client computer on the network, whereby
and initial selection of software items is pre-loaded on a mass storage system,
the mass storage system is integrated into a client computer system,
functions are provided:
to allow the storage system to be re-stocked with more software items by communicating a request to a distribution authority server that has knowledge of the software items contained on one or-more commerce servers,
the distribution authority server returning a listing of available software items for selection, or alternatively re-directing a request for a specific software item to the appropriate commerce server,
the commerce server downloading the requested software items to the storage system on the client computer
allowing the user to select software items,
to make requests to commerce servers for transactions via a network,
to manage requested transactions from a commerce server by communication with the client computer system through a network,
activate functions in the software items on the client computer system in response to authorizations of the requested functions from the commerce server.

20. A method of providing virtual retail distribution of multiple software items in a network and the capability to effect commercial transactions relative to the software from a client computer on the network, whereby
an initial selection of software items is pre-loaded on a mass storage system or the mass storage system is initially empty of software items,
the mass storage system is integrated into a client computer system,
functions are provided to:
allow the storage system to be stocked or re-stocked with more software items by communicating a request to a distribution authority server that has knowledge of the software items contained on one or more commerce servers and/or one or more client computers,
the distribution authority server returning a listing of available software items for selection, or alternatively re-directing a request for a specific software item to the appropriate commerce server or client computer,
the commerce server downloading the requested software items to the storage system on the client computer if no client computer has the requested software items,
the commerce server or one or more client computers downloading the requested software items to the storage system on the requesting client computer individually or in concert if one or more client computers has the requested software items,
allowing the user to select software items,
to make requests to commerce servers for transactions via a network,
to manage requested transactions from a commerce server by communication with the client computer system through a network,
activate functions in the software items on the client computer system in response to authorizations of the requested functions from the commerce server.

21. The method of claim 17 where the interactions necessary to complete a transaction in relation to a software item are effected by a verbal dialog between the end-user of the client computer and a human representative of the commercial entity that is granting rights under the transaction, communicated over a voice telephony network.

22. The method of claim 17 where the interactions necessary to complete a transaction in relation to a software item are effected by interaction between the end-user of the client computer and an interactive telephony application of the commercial entity that is granting rights under the transaction, communicated over a voice telephony network.

23. The method of claims 17 to 22 where the transaction is to allow the user to activate a demonstration, or evaluation or a timed, usage metered, graduated-function or full-function license or license to perform or copy for a software item and to activate the level of use associated with such licence.

24. The method of claims 17 to 22 where the software item is an advertisement, solicitation or promotional material which may be selected to initiate a transaction to purchase, lease, rent, license, or otherwise gain rights to enjoy tangible goods or services.

25. The method of claims 17 to 24 where the transaction may be completed by a single interactive gesture by the end-user, such as clicking on a button or link on the screen.

26. The method of claims 17 to 24 where the transaction may require an extended interactive dialog of multiple stages by the end-user to complete the transaction.

27. The method of claims 17 to 26 where a software management function is provided that provides a common set of interactive transaction routines for all software items.

28. The method of claims 17 to 27 where a virtual application environment function is provided which serves as an isolation proxy for any of the software items that are loaded on the storage devices of any of the described embodiments so that communication of user interaction events, and/or program parameters, and/or data between software items and the operating environment passes through the virtual application environment, allowing the introduction of control functions that may be applied to any and all of the plurality of software items.

29. The method of claim 28 where an installation proxy is inserted in the virtual application environment so that any software pre-loaded, or loaded onto the system, is stored as an installed image and can execute directly without an installation function.

30. The method of claim 29 where the installation proxy includes provisions for the user to fine-tune or otherwise alter the parameters of individual software applications.

31. The method of claim 28 where a digital rights management system functions are inserted in the virtual application environment on the client computer and on commerce servers that manage transactions to authorize specific licensed usages of software items on the client computers.

32. The method of claim 31 where digital rights management system functions licensed from one or more commercial vendors of digital rights management systems are inserted in the virtual application environment on the client computer and on commerce servers that manage transactions to authorize specific licensed usages of software items on the client computers.

33. The method of claim 28 to 30 where a copy protection function is inserted in the virtual application environment on the client computer and on commerce servers that manage transactions to authorize specific licensed usages of software items on the client computers by exploiting the fact that the installed image of software items loaded on a system within the virtual application environment installation proxy function cannot be directly executed on another computer without the virtual application environment and installation proxy function.

34. A method of manufacture of the storage system of claim 5 whereby software items are pre-loaded on a hard disk drive during the testing phase of manufacture.

35. A method of manufacture of the storage system of claim 5 whereby software items are pre-loaded on a storage system during the testing phase of manufacture and left on the storage system after the removal of other test-stage data.

36. A method of manufacture of the storage system of claim 5 whereby software items are pre-loaded on a storage system after the testing phase of manufacture.

37. A method of manufacture of the storage system of claim 5 whereby software items are pre-loaded on a storage system in the retail distribution process before purchase by the end-user.

38. A method of manufacture of the storage system of claim 5 whereby software items are pre-loaded on a storage system in the OEM distribution process before purchase by the OEM manufacturer.

39. A method of manufacture of the storage system of claim 5 whereby software items are pre-loaded on a storage system by the OEM manufacturer.

40. A method of manufacture of the end-user computer system of claim 6 whereby the storage system is integrated with the computer system in the process of manufacture.

41. A method of manufacture of the end-user computer system of claim 6 whereby the storage system is integrated with the computer system in the process of manufacturing assembly.

42. A method of manufacture of the end-user computer system of claim 6 whereby the storage system is integrated with the computer system in the process of manufacturing test.

43. A method of manufacture of the end-user computer system of claim 6 whereby the storage system is integrated with the computer system in the process of distribution.

44. A method of manufacture of the end-user computer system of claim 6 whereby the storage system is integrated with the computer system by the retailer selling to an end-user.

45. A method of manufacture of the end-user computer system of claim 6 whereby the storage system is integrated with the computer system by a system integrator selling to an end-user organization.

46. A computer-readable medium having stored thereon a computer software for use on a client computer in a network in providing virtual retail distribution of multiple software items in a client/server or peer-to-peer network and the capability to effect commercial transactions relative to the software from a client computer on the network.

47. The computer-readable medium of claim 46 having stored thereon computer software modules that allow the user to select software items and make requests to commerce servers for transactions via the network and to respond to requests for software items and to download requested items to another client computer and to activate functions in the software items in response to authorizations of the requested functions.

48. A computer-readable medium having stored thereon a computer software for use on a server computer in a network in providing virtual retail distribution of multiple software items in a network and the capability to effect commercial transactions relative to the software from a client computer on the network.

49. The computer-readable medium of claim 48 having stored thereon computer software modules that allow the server computer to receive and respond to requests for transactions from client computers and to authorize functions in the software items on the client computer once the pre-conditions of the transaction have been met.

50. The computer-readable medium of claim 47 having stored thereon computer software modules provide consistent user interactions for managing a plurality of different software items.

51. The computer-readable medium of claim 47 having stored thereon computer software modules providing a virtual application environment that serves as an isolation proxy for the parameters and/or user interaction events and/or data transfers for software items.

52. The computer-readable medium of claim 51 having stored thereon computer software modules providing an installation proxy within the virtual application environment that serves to circumvent the need to install multiple software items individually.

53. The computer-readable medium of claim 51 having stored thereon computer software modules providing an installation proxy within the virtual application environment that serves to circumvent the need to install multiple software items individually.

54. The computer-readable medium of claim 51 having stored thereon computer software modules providing a digital rights management function within the virtual application environment that serves to limit the use of software items to functions and uses which are expressly authorized by the rights holders of the software items.

55. The computer-readable medium of claim 51 having stored thereon computer software modules providing a copy protection function within the virtual application based on exploiting the absence of installation functions in software items stored on the client computer.

56. The computer-readable medium of claim 48 having stored thereon computer software modules that allow the server computer to operate as a distribution authority server in a network with multiple servers or in a peer-to-peer network providing a centralized knowledge of the location of software items and functions in the network, delivering lists of available software items and transactions to client computers, and re-directing requests for specific software items and transactions to the server that can provide them.
